(19) United States
(12) Patent Application Publication
(10) Pub. No.: US 2008/0125530 A1
(43) Pub. Date: May 29, 2008

(54) USE OF A SYNTHETIC WAX OXIDATE AS PROCESSING AID FOR TRANSPARENT POLAR POLYMERS

(75) Inventors: Udo Spitzer, Haltern am See (DE); Volker Schrenk, Herten (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Dusseldorf (DE)

(21) Appl. No.: 11/942,018

(22) Filed: Nov. 19, 2007

(30) Foreign Application Priority Data
Nov. 25, 2006 (DE) 102006055727.1

(51) Int. Cl. C08K 5/04

(52) U.S. Cl. 524/275

(57) ABSTRACT

The use of a synthetic wax oxidate having a number-average molecular weight in the range from 300 to 1000 g/mol and an acid number in the range from 15 to 60 mg KOH/g as a processing aid for a moulding compound which contains a polar polymer which in at least 60% of the repeating units contains at least one group selected from ester groups, amide group, sulphone groups and imide groups produces a good release effect and also mouldings whose transparency is undiminished by the processing aid.

### BACKGROUND OF THE INVENTION

1. Field of the Invention

The present invention relates to a processing aid for a moulding compound, the processing aid being a synthetic wax oxidate.

2. Discussion of the Background

Transparent polar polymers such as polycarbonate, polymethyl methacrylate or transparent polyamides are distinguished by mechanical resistance, good heat distortion resistance and very good optical properties, i.e., in particular, high transparency. For these reasons they are frequently used in fields of application in which these special properties are of particular benefit, as in the production, for example, of compact discs or DVDs, spectacle lenses, optical lenses and other optical elements or car headlamps.

In order to simplify processing, more particularly by injection moulding or extrusion, lubricant and release additives are needed, but must not have any adverse effect on the transparency. In the case of polycarbonate, for example, high molecular mass fatty acid esters, such as pentaerythritol tetrastearate, are typically employed. Although their relatively high compatibility means that their effect on the transparency is very low, their lubricity and release effects are nevertheless not always satisfactory.

U.S. Pat. No. 4,097,435 describes how polycarbonate moulding compounds containing glass fibre can be produced by adding montan ester wax release agents. The moulding compound preferably contains pigments, probably in order to mask the inherent colour of the montan ester wax.

Synthetic hard paraffins, i.e. polyethylene waxes and Fischer-Tropsch waxes without chemical functionality, are used as lubricants and release agents in the processing of a large number of different plastics. In transparent polar polymers, however, they have hardly been used at all to date, since despite their good release effect they lead to hazing, in the case of transparent polycarbonate for instance.

Esterified wax oxidates are suitable lubricants and release agents for unplasticized PVC (EP-A-0 498 417, EP-A-0 170 014 and EP-A-0 172 339). With other polar polymers, such as with polycarbonate, they likewise reduce the coefficient of sliding friction and hence improve the release effect, but here their use also results in distinct hazing. In fractions of any more than 0.25% by weight, partially hydrolyzed synthetic wax oxidate leads to yellowing and to decomposition of the polycarbonate in processing.

WO 2005/075190 specifies a multiplicity of lubricants for polar transparent polymers such as PMMA, polycarbonate, polyesters, polyamides, polyether-sulphones, polyimides and the like. Details of the release effect are not given.

### SUMMARY OF THE INVENTION

It is an object of the present invention to provide a lubricant and release agent that achieves the good release and lubricity effect of the unfunctionalized synthetic hard paraffins without adversely affecting the transparency of the processed polar polymer.

This and other objects have been achieved by the present invention the first embodiment of which includes a processing aid for a moulding compound, comprising:

a synthetic wax oxidate having
a number-average molecular weight Mₙ as measured via high-temperature GPC according to ASTM D 6474-99 in the range from 300 to 1000 g/mol; and
an acid number in the range from 15 to 60 mg KOH/g as determined according to DIN 53 402;

wherein said moulding compound comprises a polar polymer having repeating units;

wherein at least 60% of the repeating units contain at least one group selected from the group consisting of ester groups, amide groups, sulphone groups, imide groups and mixtures thereof.

In another embodiment, the present invention relates to a moulding composition, comprising:

a polar polymer having repeating units, wherein at least 60% of the repeating units contain at least one group selected from the group consisting of ester groups, amide groups, sulphone groups, imide groups and mixtures thereof; and

a synthetic wax oxidate having
a number-average molecular weight Mₙ as measured via high-temperature GPC according to ASTM D 6474-99 in the range from 300 to 1000 g/mol; and
an acid number in the range from 15 to 60 mg KOH/g as determined according to DIN 53 402.

In yet another embodiment, the invention relates to a moulding produced from the above moulding composition and being suitable for optical applications.

The present invention also relates to a method of improving a sliding friction coefficient of a moulding compound, comprising:

adding a processing aid comprising

a synthetic wax oxidate having
a number-average molecular weight Mₙ as measured via high-temperature GPC according to ASTM D 6474-99 in the range from 300 to 1000 g/mol; and
an acid number in the range from 15 to 60 mg KOH/g as determined according to DIN 53 402;

to a moulding compound comprising a polar polymer having repeating units;

wherein at least 60% of the repeating units contain at least one group selected from the group consisting of ester groups, amide groups, sulphone groups, imide groups and mixtures thereof; and

wherein the sliding friction coefficient is improved compared to said moulding compound without the processing aid.

### DETAILED DESCRIPTION OF THE INVENTION

An object of the present invention is achieved through the use of a synthetic wax oxidate having a number-average molecular weight Mₙ as measured via high-temperature GPC according to ASTM D 6474-99 in the range from 300 to 1000 g/mol and preferably in the range from 400 to 800 g/mol and an acid number in the range from 15 to 60 mg KOH/g and preferably in the range from 20 to 50 mg KOH/g as determined to DIN 53 402 as a processing aid for a moulding compound which contains a polar polymer which in at least 60% of the repeating units contains at least one group selected from ester groups, amide groups, sulphone groups and imide groups.

The number-average molecular weight Mₙ includes all values and subvalues therebetween, especially including 350, 400, 450, 500, 550, 600, 650, 700, 750, 800, 850, 900 and 950 g/mol. The acid number includes all values and subvalues therebetween, especially including 20, 25, 30, 35, 40, 45, 50 and 55 mg KOH/g.

Moulding compounds which contain a polymer and 0.05% to 1.5% by weight of a synthetic wax oxidate according to the present invention, and mouldings, particularly those suitable for optical applications, produced from the moulding compound of the invention are likewise provided by the present invention.

The wax oxidate is added to the moulding compound in general at 0.05% to 1.5% by weight, preferably at 0.1% to 1% by weight, with particular preference at 0.12% to 0.8% by weight and with very particular preference at 0.15% to 0.6% by weight, the percentages being based on the moulding compound containing the wax oxidate. The amount of wax oxidate includes all values and subvalues therebetween, especially including 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4 and 1.45% by weight.

The production of synthetic wax oxidates is state of the art. They are generally prepared by blowing air into melted hard paraffin at 120 to 250° C. and more particularly at 130 to 180° C., preferably in the presence of a metal catalyst or of a seed material which is in turn a hard paraffin oxidate. The temperature includes all values and subvalues therebetween, especially including 130, 140, 150, 160, 170, 180, 190, 200, 210, 220, 230 and 240° C. Particularly suitable in the context of the invention are synthetic hard paraffins which have been prepared by the Fischer-Tropsch process, and polyethylene hard paraffins having a suitable low molecular weight of, for example, less than 1200 g/mol (number-average Mₙ from high-temperature GPC according to ASTM D 6474-99).

In the polar polymer the groups as per the claim may be disposed either in the main chain or on the main chain. As-claimed polymers with ester groups are, for example, polycarbonates (esters of carbonic acid), polyestercarbonates, thermoplastic polyesters or polyalkyl (meth)acrylates.

As claimed polymers with amide groups are, for example, polyamides, polyamideimides and polyesteramides, whereas as-claimed polymers with sulphone groups may be, for example, polysulphone. As-claimed polymers with imide groups are, for example, polyimides, polyglutar-imides and polyetherimides. The as-claimed polymers are present in the moulding compound generally to an extent of at least 50% by weight, preferably at least 60% by weight, with particular preference at least 70% by weight and with especial preference at least 80% by weight.

Polycarbonates suitable in accordance with the invention contain units which are carbonic diesters of diphenols. Diphenols of this kind may, for example, be the following: hydroquinone, resorcinol, dihydroxy-biphenyls, bis(hydroxyphenyl)alkanes, bis(hydroxy-phenyl)cycloalkanes, bis(hydroxyphenyl) sulphides, bis(hydroxyphenyl)ethers, bis(hydroxyphenyl) ketones, bis(hydroxyphenyl) sulphones, bis(hydroxyphenyl) sulphoxides, α,α′-bis-(hydroxyphenyl)diisopropylbenz-enes, and their ring-alkylated or ring-halogenated derivatives, or else α,ω)-bis(hydroxyphenyl)polysil-oxanes.

Examples of preferred diphenols are 4,4′-dihydroxybiphenyl, 2,2-bis(4-hydroxyphenyl)propane (bisphenol A), 1,1-bis(4-hydroxyphenyl)-3,3,5-trimethylcyclohexane, 1,1-bis(4-hydroxyphenyl)cyclohexane, 2,4-bis(4-hydroxyphenyl)-2-methylbutane, 1,1-bis(4-hydroxyphenyl)-1-phenylethane, 1,1-bis(4-hydroxyphenyl)-p-diisopropylbenzene, 1,3-bis[2-(4-hydroxyphenyl)-2-propyl]benzene, 2,2-bis(3-methyl-4-hydroxyphenyl)propane, 2,2-bis(3-chloro-4-hydroxy-phenyl)propane, bis(3,5-dimethyl-4-hydroxyphenyl)-methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 2,2-bis(3,5-dichloro-4-hydroxyphenyl)propane and 2,2-bis(3,5-dibromo-4-hydroxyphenyl)propane.

The diphenols can be used both alone and in a mixture with one another. They are known from the literature or can be prepared by methods known from the literature (see, for example, H. J. Buysch et al., Ullmann's Encyclopedia of Industrial Chemistry, VCH, New York 1991, 5th ed., Vol. 19, p. 348).

The polycarbonates used in accordance with the invention are prepared by known methods, such as by the phase boundary method or by the melt trans-esterification method, for example. They possess weight-average molecular weights M_{w} (determined by gel permeation chromatography and calibration with polystyrene standard) of from 5000 g/mol to 200000 g/mol, preferably from 10000 g/mol to 80000 g/mol and with particular preference from 15000 g/mol to 40000 g/mol.

The polycarbonate moulding compound may further contain, at less than 50% by weight, preferably at less than 40% by weight, with particular preference at less than 30% by weight and with especial preference at less than 20% by weight, based on the overall polymer basis, of other polymers, such as, for example, polyethylene terephthalate, polybutylene terephthalate, polyesters formed from cyclohexanedimethanol, ethylene glycol and terephthalic acid, polyesters formed from cyclohexane-dimethanol and cyclohexanedicarboxylic acid, polyalkyl (meth)acrylates, SAN, styrene-(meth)acrylate copolymers, polystyrene (amorphous or syndiotactic), polyetherimides, polyimides, polysulphones and/or polyarylates (based for example on bisphenol A and isophthalic acid/terephthalic acid).

Polyestercarbonates are synthesized from at least one diphenol, from at least one aromatic dicarboxylic acid and from carbonic acid. Suitable diphenols are the same as for polycarbonate. The fraction originating from aromatic dicarboxylic acids, based on the sum of the fractions originating from aromatic dicarboxylic acids and from carbonic acid, is not more than 99.9 mol %, not more than 95 mol %, not more than 90 mol %, not more than 85 mol %, not more than 80 mol % or not more than 75 mol %, while its minimum fraction is 0.1 mol %, 5 mol %, 10 mol %, 15 mol %, 20 mol % or 25 mol %. Examples of suitable aromatic dicarboxylic acids are orthophthalic acid, terephthalic acid, isophthalic acid, tert-butylisophthalic acid, 3,3′-diphenyldicarboxylic acid, 4,4′-diphenyl ether dicarboxylic acid, 4,4′-diphenyl sulphone dicarboxylic acid, 3,4′-benzophenonedicarboxylic acid, 2,2-bis(4-carboxy-phenyl)propane and trimethyl-3-phenylindane-4,5-dicarboxylic acid. Of these it is preferred to use terephthalic acid and/or isophthalic acid.

Suitable thermoplastic polyesters are preferably either of all-aromatic construction or of mixed aliphatic/aromatic construction. In the former case they are polyarylates; these are derived from diphenols and aromatic dicarboxylic acids. Suitable diphenols are the same as for polycarbonate, while suitable dicarboxylic acids are the same as for polyestercarbonates. In the latter case the polyesters are derived from one or more aromatic dicarboxylic acids and also one or more diols; for example they are polyethylene terephthalate or are copolyesters formed from terephthalic acid, 1,4-cyclohexanedimethanol and ethylene glycol.

Suitable polyalkyl (meth)acrylates are primarily those having 1 to 6 carbon atoms in the carbon chain of the alkyl radical, the methyl group being a preferred alkyl group. The polyalkyl (meth)acrylates typically have a melt flow rate of 0.5 to 30 g/10 min, preferably 0.8 to 15 g/10 min, measured to ISO 1133 at 230° C. with a load of 3.8 kg. The melt flow rate includes all values and subvalues therebetween, especially including 1, 5, 10, 15, 20, and 25 g/10 min.

Examples include polymethyl methacrylate and polybutyl methacrylate. Copolymers of the polyalkyl (meth)acrylates, however, can also be employed. Thus it is possible for up to 40%, preferably up to 30% and with particular preference up to 20% by weight of the alkyl (meth)acrylate to have been replaced by other monomers such as, for example, (meth)acrylic acid, styrene, acrylonitrile, acrylamide or the like. The moulding compound may have been toughened, by addition for example of a core/shell rubber typical of such moulding compounds. Furthermore, there may be less than 50%, preferably not more than 40%, with particular preference not more than 30% and with especial preference not more than 20% by weight of other thermoplastics such as, for example, SAN (styrene/acrylonitrile copolymer) and/or polycarbonate.

Suitable polyamides are preferably those which are transparent; examples of such are

the polyamide formed from 1,12-dodecanedioic acid and 4,4′-diaminodicyclohexylmethane;

the polyamide formed from terephthalic acid and/or isophthalic acid and the isomer mixture of 2,2,4- and 2,4,4-trimethylhexamethylenediamine,

the polyamide formed from isophthalic acid and 1,6-hexamethylenediamine,

the copolyamide formed from a mixture of terephthalic acid/isophthalic acid and 1,6-hexamethylenediamine, if desired in a mixture with 4,4′-diaminodicyclohexylmethane,

the copolyamide formed from terephthalic acid and/or isophthalic acid, 3,3′-dimethyl-4,4′-diaminodicyclohexylmethane and laurolactam or caprolactam,

the (co)polyamide formed from 1,12-dodecanedioic acid or sebacic acid, 3,3′-dimethyl-4,4′-diaminodicyclohexylmethane and, if desired, laurolactam or caprolactam,

the copolyamide formed from isophthalic acid, 4,4′-diaminodicyclohexylmethane and laurolactam or caprolactam,

the polyamide formed from 1,12-dodecanedioic acid and 4,4′-diaminodicyclohexylmethane (with a low trans,trans isomer fraction),

the copolyamide formed from terephthalic acid and/or isophthalic acid and also an alkyl-substituted bis(4-aminocyclohexyl)methane homologue, if desired in a mixture with hexamethylenediamine,

the copolyamide formed from bis(4-amino-3-methyl-5-ethylcyclohexyl)methane, if desired together with a further diamine and also isophthalic acid, if desired together with a further dicarboxylic acid,

the copolyamide formed from a mixture of m-xylylenediamine and a further diamine, such as hexamethylenediamine, and also isophthalic acid, if desired together with a further dicarboxylic acid such as terephthalic acid and/or 2,6-naphthalenedicarboxylic acid, for example,

the copolyamide formed from a mixture of bis(4-aminocyclohexyl)methane and bis(4-amino-3-methylcyclohexyl)methane and also aliphatic dicarboxylic acids having 8 to 14 carbon atoms, and

polyamides or copolyamides formed from a mixture which contains 1,14-tetradecanedioic acid and also an aromatic, arylaliphatic or cycloaliphatic diamine.

These examples can be varied very extensively by adding further components (e.g. caprolactam, laurolactam or diamine/dicarboxylic acid combinations) or by replacing some or all of starting components with other components.

The stated polyamides and also further suitable largely amorphous polyamides and also suitable preparation methods are described in patent applications including the following: WO 02090421, EP-A-0 603 813, DE-A 37 17 928, DE-A 100 09 756, DE-A 101 22 188, DE-A 196 42 885, DE-A 197 25 617, DE-A 198 21 719, DE-C 198 41 234, EP-A-1 130 059, EP-A 1 369 447, EP-A 1 595 907, CH-B-480 381, CH-B 679 861, DE-A-22 25 938, DE-A-26 42 244, DE-A-27 43 515, DE-A-29 36 759, DE-A-27 32 928, DE-A-43 10 970, EP-A-0 053 876, EP-A-0 271 308, EP-A-0 313 436, EP-A-0 725 100 and EP-A-0 725 101.

Suitable polysulphones are generally prepared by polycondensation of a bisphenol/dihalodiaryl sulphone mixture in an aprotic solvent in the presence of a base such as sodium carbonate, for example. Examples of bisphenols which can be used are those also suitable for preparing polycarbonates, but especially bisphenol A, 4,4′-dihydroxydiphenyl sulphone, 4,4′-dihydroxybiphenyl and hydroquinone, it also being possible to use mixtures of different bisphenols. The dihalogen compound is 4,4′-dichlorodiphenyl sulphone in a majority of cases; it is also possible, however, to use any other dihalogen compound for which the halogen is activated by a sulphone group in para position. Suitable halogen besides chlorine is also fluorine. The term “polysulphone” also includes the polymers typically referred to as “polyether sulphone” or “polyphenylene sulphone”. Suitable types are available commercially.

Polyimides are prepared in a known way from tetracarboxylic acids or their anhydrides and diamines. If the tetracarboxylic acid and/or the diamine contain some ether group the result is a polyetherimide. One particularly suitable tetracarboxylic acid containing ether groups is the compound I; together with aromatic diamines, it produces amorphous polyetherimides, which are available commercially.

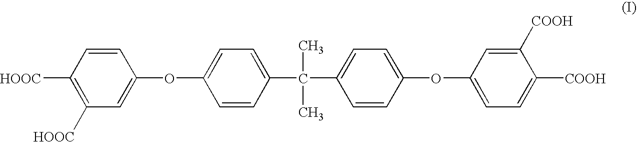

Other suitable polyimides are polyglutarimides, sometimes also referred to as polyacrylimides or polymethacrylimides. These are products starting from polyalkyl acrylates or polyalkyl methacrylates, where two adjacent carboxylate groups have been reacted to form a cyclic acid imide. The imidization is preferably carried out with ammonia and/or primary amines, such as methylamine. The products and also their preparation are known (Hans R. Kricheldorf, Handbook of Polymer Synthesis, Part A, Verlag Marcel Dekker Inc. New York-Base1-Hong Kong, p. 223 f., H. G. Elias, Makromoleküle, Hüthig and Wepf Verlag Base1-Heidelberg-New York; U.S. Pat. No. 2,146,209 A; U.S. Pat. No. 4,246,374).

In the as-claimed polymers not more than 40% of the repeating units may be of a different composition; in the case of polycondensates, for example, the groups in question may be oxyalkylene or siloxane groups. Here it is possible, for example, for difunctional polyethylene oxide, polypropylene oxide, polytetrahydrofuran or polydimethylsiloxane blocks to have been incorporated into the polymer chain.

The as-claimed moulding compound may contain further conventional auxiliaries or additives such as, for example, stabilizers, processing aids, flame retardants, plasticizers, antistats, isorefractive fillers or reinforcing agents, isorefractive impact modifiers, dyes which do not significantly affect the transparency, flow aids or other polymers which do not significantly affect the transparency. The amount of all auxiliaries and additives in total is not more than 50%, preferably not more than 40%, with particular preference not more than 30% and with especial preference not more than 20% by weight.

In the context of the as-claimed use a considerable reduction is achieved in the coefficient of sliding friction and consequently a considerable improvement in the release effect and also in the MFI, without any adverse effect on the transparency of the processed moulding compound. Thus systems of the invention, in other words mouldings produced using the moulding compounds of the invention, within the visible spectrum from 380 to 800 nm at a path length of 3.5 mm, exhibit a maximum in the transmittance curve of at least 30% and preferably at least 35%, 40%, 45%, 50%, 55%, 60%, 65%, 70%, 75% or 80%, the transparency being determined according to ASTM D 1003 on injection-moulded sheets.

Surprisingly, furthermore, the formation of deposits on the screws, barrels and dies and on the mould surfaces is avoided with the as-claimed processing aid. At the same time, articles with outstanding surface quality are obtained, in terms both of their optical impression and capacity for assembly. Thus, for example, optical lenses must be provided with scratch-resistant coats; CDs and DVDs are provided, if desired, with a dye coat and also with a reflective metal coat; in other cases a protective coat or a decorative coat is applied by multi-component injection moulding, injection back-moulding of a protective or decorative film, compression moulding, laminating, compression back-moulding, etc. In all of these cases no reduction in adhesion as a result of the processing aid is observed.

In one preferred embodiment the mouldings obtained are used for optical applications. Examples thereof are optical storage media such as CDs and DVDs, diffuser discs, headlamp lenses, lenses of rear lights, optical lenses, prisms, spectacle lenses, displays, decorative components for displays, glazing of all kinds, and mobile telephone casings.

Even without further remarks it is assumed that a person skilled in the art will be able to utilize the above description in its broadest extent. Consequently the preferred embodiments and examples are to be interpreted merely as a descriptive disclosure which in no way has any limiting effect whatsoever.

Having generally described this invention, a further understanding can be obtained by reference to certain specific examples which are provided herein for purposes of illustration only, and are not intended to be limiting unless otherwise specified.

### EXAMPLES

The present invention is illustrated below with reference to examples. Alternative embodiments of the present invention are obtainable in a similar way.

The materials used in the inventive and comparative examples were as follows:

PC: a commercial polycarbonate (Makrolon® 2808, Bayer Material Science)

PETS (not inventive): pentaerythritol tetrastearate

Wax 1 and wax 2 (not inventive): synthetic hard paraffins; for data see Table 1

Wax 3 to wax 7: synthetic wax oxidates; for data see Table 1

### Examples 1 and 2 (According to the Invention) and Comparative Examples 1 to 5

The polycarbonate and 0.4% by weight of the processing aid were mixed in the melt to produce compounded formulations. The compounded formulations were then processed by injection moulding to form sheets (40 mm×20 mm×3.5 mm). These sheets were used for the assessment of transparency and determination of the coefficient of sliding friction, which allows conclusions to be drawn with regard to the release effect. The results are given in Table 1. In this case the transparency was assessed as follows:

+clear, no haze
0 a few streaks, slight haze
0/− severe haze
− very severe haze.

The examples show that with the as-claimed wax oxidate the high transparency typical of conventional release agents such as PETS was maintained, but that a significantly increased release effect was obtained.

| | | Average osmometric | | | |
|---|---|---|---|---|---|
| | Processing | molecular weight | Acid number | Coefficient of | |
| | aid | [g/mol] | [mg KOH/g] | sliding friction | Transparency |
| Comparative example 1 | PETS | | | 0.7 | + |
| Comparative example 2 | Wax 1 | about 700 | — | 0.4 | − |
| Comparative example 3 | Wax 2 | about 1000 | — | 0.3 | − |
| Comparative example 4 | Wax 3 | about 650 | 10 | 0.35 | 0/— |
| Example 1 | Wax 4 | about 600 | 30 | 0.3 | + |
| Example 2 | Wax 5 | about 500 | 50 | 0.4 | + |
| Comparative example 5 | Wax 6 | about 1500 | 20 | 0.3 | − |
| Comparative example 6 | Wax 7 | about 1200 | 20 | 0.3 | 0/— |

German patent application 10 2006 055 727.1 filed Nov. 25, 2006, is incorporated herein by reference.

Numerous modifications and variations on the present invention are possible in light of the above teachings. It is therefore to be understood that within the scope of the appended claims, the invention may be practiced otherwise than as specifically described herein.

1. A processing aid for a moulding compound, comprising:
a synthetic wax oxidate having
a number-average molecular weight Mₙ as measured via high-temperature GPC according to ASTM D 6474-99 in the range from 300 to 1000 g/mol; and
an acid number in the range from 15 to 60 mg KOH/g as determined according to DIN 53 402;
wherein said moulding compound comprises a polar polymer having repeating units;
wherein at least 60% of the repeating units contain at least one group selected from the group consisting of ester groups, amide groups, sulphone groups, imide groups and mixtures thereof.

2. The processing aid according to claim 1, wherein the average molecular weight of the wax oxidate is in the range from 400 to 800 g/mol.

3. The processing aid according to claim 1, wherein the acid number of the wax oxidate is in the range from 20 to 50 mg KOH/g.

4. The processing aid according to claim 1, wherein the wax oxidate has been prepared by oxidizing a Fischer-Tropsch wax or a polyethylene hard paraffin.

5. The processing aid according to claim 1, wherein the polar polymer is a polycarbonate, a polyestercarbonate, a thermoplastic polyester, a polyalkyl (meth)-acrylate, a polyamide, a polyamideimide, a poly-esteramide, a polysulphone, a polyimide, a poly-glutarimide or a polyetherimide.

6. A moulding composition, comprising:
a polar polymer having repeating units, wherein at least 60% of the repeating units contain at least one group selected from the group consisting of ester groups, amide groups, sulphone groups, imide groups and mixtures thereof; and
a synthetic wax oxidate having
a number-average molecular weight Mₙ as measured via high-temperature GPC according to ASTM D 6474-99 in the range from 300 to 1000 g/mol; and
an acid number in the range from 15 to 60 mg KOH/g as determined according to DIN 53 402.

7. The moulding composition according to claim 6, comprising 0.05% to 1.5% by weight of said wax oxidate.

8. The moulding composition according to claim 6, wherein the average molecular weight of the wax oxidate is in the range from 400 to 800 g/mol.

9. The moulding composition according to claim 6, wherein the acid number of the wax oxidate is in the range from 20 to 50 mg KOH/g.

10. The moulding composition according to claim 6, wherein the wax oxidate has been prepared by oxidizing a Fischer-Tropsch wax or a polyethylene hard paraffin.

11. The moulding composition according to claim 6, wherein the polar polymer is a polycarbonate, a polyestercarbonate, a thermoplastic polyester, a polyalkyl (meth)-acrylate, a polyamide, a polyamideimide, a poly-esteramide, a polysulphone, a polyimide, a poly-glutarimide or a polyetherimide.

12. A moulding produced from the moulding composition according to claim 6, said moulding being suitable for optical applications.

13. The moulding according to claim 12, which, within the visible spectrum from 380 to 800 nm at a path length of 3.5 mm, exhibits a maximum in the transmittance curve of at least 30%, a transparency being determined according to ASTM D 1003 on injection-moulded sheets.

14. The moulding according to claim 12, comprising 0.05% to 1.5% by weight of said wax oxidate.

15. The moulding according to claim 12, wherein the average molecular weight of the wax oxidate is in the range from 400 to 800 g/mol.

16. The moulding according to claim 12, wherein the acid number of the wax oxidate is in the range from 20 to 50 mg KOH/g.

17. The moulding according to claim 12, wherein the wax oxidate has been prepared by oxidizing a Fischer-Tropsch wax or a polyethylene hard paraffin.

18. The moulding according to claim 12, wherein the polar polymer is a polycarbonate, a polyestercarbonate, a thermoplastic polyester, a polyalkyl (meth)-acrylate, a polyamide, a polyamideimide, a poly-esteramide, a polysulphone, a polyimide, a poly-glutarimide or a polyetherimide.

19. A method of improving a sliding friction coefficient of a moulding compound, comprising:
adding a processing aid comprising
a synthetic wax oxidate having
a number-average molecular weight Mₙ as measured via high-temperature GPC according to ASTM D 6474-99 in the range from 300 to 1000 g/mol; and
an acid number in the range from 15 to 60 mg KOH/g as determined according to DIN 53 402;
to a moulding compound comprising a polar polymer having repeating units;
wherein at least 60% of the repeating units contain at least one group selected from the group consisting of ester groups, amide groups, sulphone groups, imide groups and mixtures thereof; and
wherein the sliding friction coefficient is improved compared to said moulding compound without the processing aid.

20. The method of claim 19, wherein 0.05% to 1.5% by weight of said wax oxidate are added to said moulding compound.
